(19) United States
(12) Patent Application Publication
(10) Pub. No.: US 2004/0054682 A1
(43) Pub. Date: Mar. 18, 2004

(54) Hypertext analysis method, analysis program, and apparatus

(76) Inventor: Makoto Kano, Inagi-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/659,638

(22) Filed: Sep. 11, 2003

(30) Foreign Application Priority Data
Sep. 13, 2002 (JP) 2002-268268

(51) Int. Cl. G06F 7/00

(52) U.S. Cl. 707/100

(57) ABSTRACT

Access history information to respective pages of hypertext is fetched, one or a plurality of pages is/are as a target page or pages, and the fetched access history information is divided into a plurality of sessions each indicating a series of accesses. A page sequence in the order of transition of pages included in each of the divided sessions is generated. Each of the sessions, which accesses the target page, is determined as a successful session, and a session, which does not access the target page, is determined as an unsuccessful session. The number of sessions and success ratio are calculated for each page, and the respective pages are displayed as a graph to have the number of sessions and success ratio as parameters.

### CROSS-REFERENCE TO RELATED APPLICATIONS

This application is based upon and claims the benefit of priority from the prior Japanese Patent Application No. 2002-268268, filed Sep. 13, 2002, the entire contents of which are incorporated herein by reference.

### BACKGROUND OF THE INVENTION

1. Field of the Invention

The present invention relates to a hypertext analysis method, hypertext analysis program, and hypertext analysis apparatus, which analyze hypertext that is formed in a network server and links a plurality of pages with each other.

2. Description of the Related Art

Hypertext that links a plurality of pages with each other is formed in a network server such as a Web server connected to the Internet to which the general public can access. A system that allows outsiders (visitors) to arbitrarily browse respective pages of this hypertext is in practical use.

Each page of such hypertext contains a plurality of icons or anchors used to designate the link destination of the next related page by the visitor. If this hypertext is a home page of business guide, Web sales, or the like, how to efficiently make transition of pages to a page that describes required information and to display that page is an issue for visitors (customers) who access this home page.

Therefore, it is very important to analyze actual visitors' (customers') access sequences of pages of the hypertext formed in the network server.

As a conventional hypertext analysis method, Jpn. Pat. Appln. KOKAI Publication No. 2001-166981 discloses “Hypertext Analysis Apparatus and Method”. In “Hypertext Analysis Apparatus and Method” disclosed by Jpn. Pat. Appln. KOKAI Publication No. 2001-166981, correlation values between various attributes extracted from page contents and inter-page transition frequencies are calculated in advance for arbitrary page sets which form hypertext. As proposed in this reference, an attribute to be changed is displayed upon increasing a given inter-page transition frequency.

Also, correlation values between various attributes extracted from page contents and inter-page access similarities are calculated in advance for arbitrary page sets. As proposed in this reference, an attribute to be changed is displayed upon increasing a given inter-page access similarity. Note that the inter-page access similarity indicates the degree at which visitors accessed both pages.

With these parameters, a hypertext administrator can change the page contents to increase the inter-page transition frequency or inter-page access similarity.

However, even in “Hypertext Analysis Apparatus and Method” disclosed by Jpn. Pat. Appln. KOKAI Publication No. 2001-166981, the following problems remain unsolved.

Jpn. Pat. Appln. KOKAI Publication No. 2001-166981 has discussed the method of increasing the transition frequency or access similarity between pages. However, this reference does not specify pages, the transition frequency or access similarity of which is to be increased in actual hypertext.

Hypertext on a Web server which is managed by a certain company on the Internet aims at increasing business chances by guiding visitors (customers) who access this home page to target pages (e.g., those for merchandise purchase, document request, inquiry, and the like). However, since Jpn. Pat. Appln. KOKAI Publication No. 2001-166981 does not specify any route used to guide a visitor to the target page, pages, the transition frequency or access similarity of which is to be increased cannot be determined.

### BRIEF SUMMARY OF THE INVENTION

It is an object of the present invention to provide a hypertext analysis method, hypertext analysis program, and hypertext analysis apparatus, which can support to reform the inter-page link configuration and page contents so as to efficiently guide visitors (access users) who access hypertext to a target page or target category (e.g., merchandise purchase, document request, inquiry, and the like), and to increase business chances.

In order to achieve the above object, according to the first aspect of the present invention, a hypertext analysis method for analyzing hypertext which is formed in a network server and links a plurality of pages with each other, comprises fetching access history information to respective pages of the hypertext stored in the network server, setting one or a plurality of pages designated from the plurality of pages that form the hypertext as a target page or pages, dividing the fetched access history information into a plurality of sessions each indicating a series of accesses, generating a page sequence in an order of transition of pages included in each of the divided sessions, and storing the page sequence in a memory, determining each of the sessions, which accesses the target page, as a successful session, and a session, which does not access the target page, as an unsuccessful session, calculating, for each of pages which form the hypertext, the number of sessions which accessed that page, and a success ratio as a ratio of the number of successful sessions to the number of access sessions, and outputting the numbers of sessions and success ratios of the respective pages as an analysis result.

Note that a session in the hypertext analysis method of the present invention indicates a series of accesses to respective pages of hypertext by one visitor (access user). The visitor (access user) is identified by, e.g., the IP (Internet Protocol) address of his or her computer. When a visitor successively accesses pages of hypertext, such successive accesses form one session. When the visitor ceases to access for a predetermined period of time or more, the session ends at that time. In this manner, access history information fetched from the network server is divided into a plurality of sessions.

Each session is determined as a successful session if it accesses the target page, or as an unsuccessful session if it does not access the target page. Finally, the number of sessions and success ratio of each page are output as an analysis result.

Therefore, an administrator can reform the inter-page link configuration and page contents with reference to this analysis result to increase the access frequency for a page with a small number of sessions and to increase the success ratio for a page with a low success ratio.

If many visitors (access users) leave a page with a low success ratio, since expectations that the visitors may have raised on the previously visited page may not match the contents of that page, the page contents or a comment on the previously visited page must be reexamined.

On the other hand, if many visitors make transition from a given page to a page with a low success ratio, a link comment must be reexamined, or the page contents must be reexamined to increase the transition frequency to another page with a high success ratio.

A page with a high success ratio but low access frequency is reformed by emphasizing, e.g., an icon that indicates a link to that page or adding a link from a page with a high access frequency so that visitors can visit that page.

More specifically, the page contents and link configurations can be modified to plot pages in a region where both the number of sessions (access frequency) and success ratio are high.

According to the second aspect of the present invention, a hypertext analysis method for analyzing hypertext which is formed in a network server and links a plurality of pages with each other, comprises fetching access history information to respective pages of the hypertext stored in the network server, classifying respective pages that form the hypertext into a plurality of categories, setting one or a plurality of categories designated from the plurality of categories as a target category or categories, dividing the fetched access history information into a plurality of sessions each indicating a series of accesses, generating a category sequence in an order of transition of categories corresponding to pages included in each of the divided sessions, and storing the category sequence in a memory, determining each of the sessions, which accesses the target category, as a successful session, and a session, which does not access the target category, as an unsuccessful session, calculating, for each of categories corresponding to the pages which form the hypertext, the number of sessions which accessed that category, and a success ratio as a ratio of the number of successful sessions to the number of access sessions, and outputting the numbers of sessions and success ratios of the respective categories as an analysis result.

The hypertext analysis method according to the second aspect of the present invention is different from that according to the first aspect of the present invention in that the categorizing hypertext pages is added and analysis is made for respective categories.

That is, when the number of pages of hypertext to be analyzed is large, huge computer resources and time are required to make analysis for respective pages. Hence, if pages can be categorized and analysis can be made for respective categories using the hypertext analysis method according to the second aspect of the present invention, huge computer resources and time are not required.

When a hypertext administrator modifies the page contents and link configurations with reference to the displayed analysis result, the analysis result for respective pages does not allow easy understanding of relations among many pages, but that for respective categories allows easy understanding of them.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the preferred embodiments given below, serve to explain the principles of the invention.

FIG. 1 is a schematic block diagram showing the arrangement of a hypertext analysis apparatus to which a hypertext analysis method according to the first embodiment of the present invention is applied and in which a hypertext analysis program is installed;

FIG. 2 is a flow chart showing the operation of the hypertext analysis apparatus of the first embodiment;

FIG. 3 shows the format of sessions used in the hypertext analysis apparatus of the first embodiment;

FIG. 4 shows the analysis result displayed on a display unit of the hypertext analysis apparatus of the first embodiment;

FIG. 5 shows the analysis result displayed on the display unit of the hypertext analysis apparatus of the first embodiment;

FIG. 6 is a schematic block diagram showing the arrangement of a hypertext analysis apparatus to which a hypertext analysis method according to the second embodiment of the present invention is applied and in which a hypertext analysis program is installed;

FIG. 7 is a flow chart showing the operation of the hypertext analysis apparatus of the second embodiment;

FIG. 8 shows the format of categories used in the hypertext analysis apparatus of the second embodiment;

FIG. 9 shows the format of a session used in the hypertext analysis apparatus of the second embodiment;

FIG. 10 shows the analysis result displayed on a display unit of the hypertext analysis apparatus of the second embodiment; and

FIG. 11 shows the analysis result displayed on the display unit of the hypertext analysis apparatus of the second embodiment.

### DETAILED DESCRIPTION OF THE INVENTION

Preferred embodiments of the present invention will be described hereinafter with reference to the accompanying drawings.

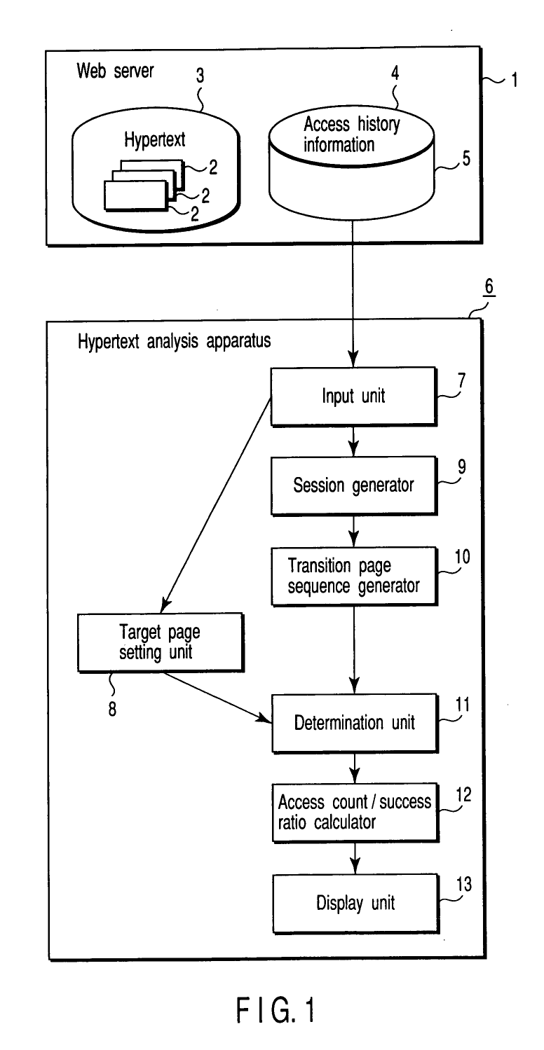

FIG. 1 is a schematic block diagram showing the arrangement of a hypertext analysis apparatus to which a hypertext analysis method according to the first embodiment of the present invention is applied and in which a hypertext analysis program is installed.

Hypertext 3 that links a plurality of pages 2 with each other is formed in a Web server 1 as a network server connected to the Internet (not shown). Arbitrary users can access (visit) respective pages 2 of the hypertext 3 formed in the Web server 1 using their computers connected to the Internet via the Internet.

When an arbitrary user accesses (visits) each page 2, a page number or URL (uniform resource locator) of that page, which specifies the page, access (visit) time, and the IP address of the computer of the access user, which specifies the access user are time-serially written in a log file 5. That is, the log file 5 stores access history information 4 to respective pages 2 of the hypertext 3.

A hypertext analysis apparatus 6, which comprises a computer connected to the Web server 1, includes an input unit 7, target page setting unit 8, session generator 9, transition page sequence generator 10, determination unit 11, and access count/success ratio calculator 12, which are implemented in an application program. Furthermore, a display unit 13 is built in the hypertext analysis apparatus 6.

The input unit 7 reads out the access history information 4 stored in the log file 5 in the Web server 1, and outputs it to the target page setting unit 8 and session generator 9.

The target page setting unit 8 sets, as a target page, a page 2 which is contained in the access history information 4, i.e., a page 2 which is to be visited (accessed) by visitors (access users) of those contained in the hypertext 3, and outputs that target page to the determination unit 11. The target page is designated by operation of an operator (administrator) of the hypertext analysis apparatus 6.

The session generator 9 divides the input access history information 4 into sessions each indicating a series of access pages of a given visitor by it into visitors (access users), and outputs page sequences of the divided sessions to the transition page sequence generator 10. Note that each visitor (access user) is identified by, e.g., the IP address of his or her computer, as described above.

The transition page sequence generator 10 rearranges the page sequence of each session input from the session generator 9 in an order of transition, and outputs it to the determination unit 11. FIG. 3 shows sessions 14 which include page sequences in the order of transition. As shown in FIG. 3, each session 14 includes a plurality of successively accessed pages 2 in the order of transition (order of access).

The determination unit 11 compares the transition-order page sequences for respective sessions 14 transmitted from the transition page sequence generator 10 with the target page transmitted from the target page setting unit 8 to check if each session 14 includes the target page. The determination unit 11 determines a session 14 which includes the target page as a successful session, and a session 14 which does not include the target page as an unsuccessful session. The determination unit 11 outputs the transition-order page sequences for respective sessions 14 and determination results to the access count/success ratio calculator 12.

The access count/success ratio calculator 12 counts the number of sessions 14 which passed (accessed) each of the pages 2 of the hypertext 3, and the number of sessions 14 which are determined as “successful sessions” of the access sessions. Then, the calculator 12 calculates a success ratio indicating the ratio of the number of successful sessions to the number of access sessions. The calculator 12 outputs the numbers of sessions and success ratios for respective pages 2 to the display unit 13.

Note that a session 14 determined as a successful session can be limited to only a page sequence until the target page is accessed upon calculating the success ratio of each page 2.

When the page sequence of a session 14 determined as a successful session is limited to only that until the target page is accessed, the influence of pages 2 which are reached (accessed) after the target page on the success ratio can be eliminated, thus improving the precision of the success ratio.

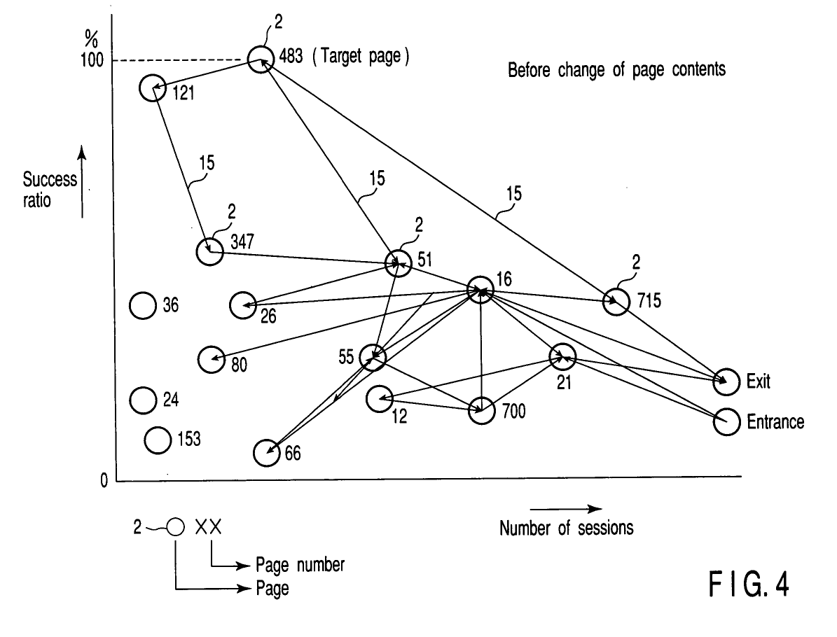

The display unit 13 plots respective pages 2 on an orthogonal coordinate system, the abscissa of which plots the number of sessions that passed a given page, and the ordinate of which plots the success ratio, as shown in FIG. 4. The graph obtained by plotting the respective pages 2 on the orthogonal coordinate system is displayed as the analysis result.

The administrator of the hypertext 3 can reform the link configuration among pages 2 of the hypertext 3 and page contents with reference to the graph of the analysis result displayed on the display unit 13.

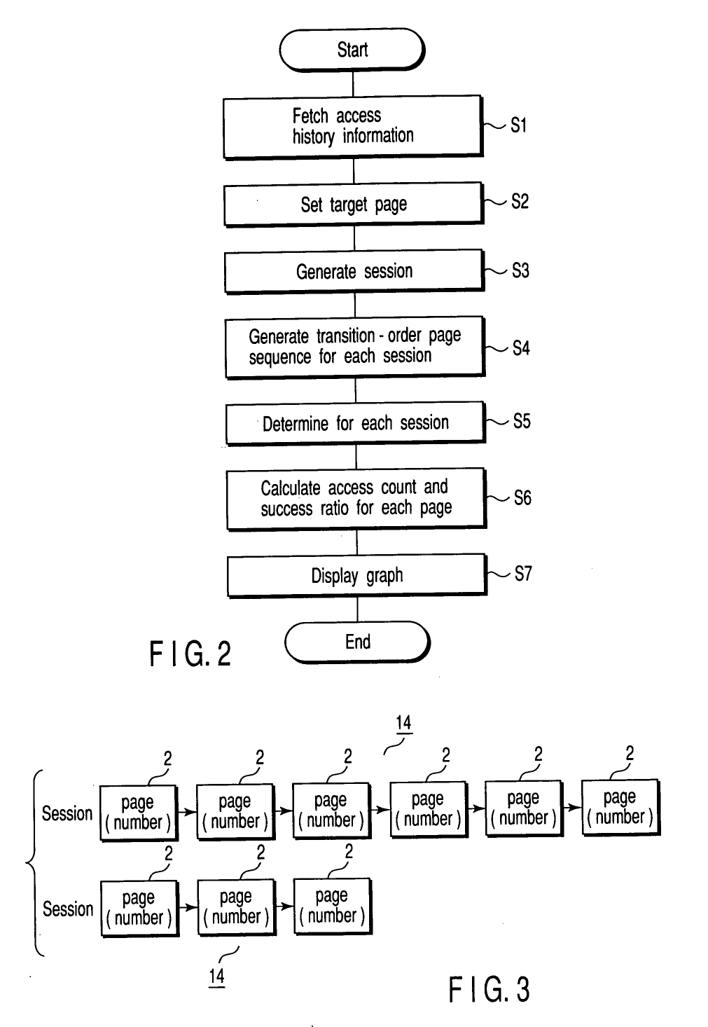

The detailed processing sequence in the hypertext analysis apparatus 6 with the above arrangement will be described below using the flow chart of FIG. 2.

The input unit 7 reads out the access history information 4 stored in the Web server 1 and outputs it to the session generator 9 and target page setting unit 8 (step S1). The target page setting unit 8 sets, as a target page, a page 2 to be visited by visitors of those of the hypertext 3, and outputs it to the determination unit 11 (step S2).

The session generator 9 divides the input access history information 4 into a plurality of sessions, each of which indicates a series of accesses to respective pages 2 by one visitor (access user), and outputs the divided sessions to the transition page sequence generator 10 (step S3).

The transition page sequence generator 10 rearranges each of the sessions 14 input from-the session generator 9 to a transition-order page sequence, and outputs the page sequences to the determination unit 11 (step S4). The determination unit 11 compares the transition-order page sequences for respective sessions 14 with the target page. The unit 11 determines a session 14 that includes the target page as a successful session, and a session 14 that does not include any target page as an unsuccessful session. The unit 11 outputs the determination result to the access count/success ratio calculator 12 (step S5).

The access count/success ratio calculator 12 calculates the number of sessions 14 that passed each of the pages 2 of the hypertext 3 and the success ratio, and outputs them to the display unit 13 (step S6). The display unit 13 displays the graph of the analysis result obtained by plotting the respective pages 2 on the orthogonal coordinate system the abscissa of which plots the number of sessions that passed a given page, and the ordinate of which plots the success ratio (step S7).

The analysis result obtained upon analyzing the hypertext 3 actually formed in the Web server 1 using the hypertext analysis apparatus 6 of the first embodiment with the above arrangement will be described below using FIG. 4.

The hypertext analysis apparatus 6 of this embodiment analyzes the hypertext 3 which is made up of a plurality of pages 2 that are linked with each other and practices Web sales of merchandise via the Internet. Therefore, a page 2 on which each visitor (access user=customer) finally instructs to purchase merchandise is set as a target page.

On the graph of the analysis result in FIG. 4, each circle indicates a page 2, and a numeral on the right side of the circle indicates a page number used to specify the page 2. Furthermore, the abscissa plots the number of sessions 14 that passed each page 2, and the ordinate plots the success ratio indicating the ratio of the number of successful sessions 14 that passed the target page of the number of sessions 14 that passed each page 2.

Furthermore, each directed line segment 15 that connects between pages 2 on the graph represents inter-page transition (inter-page access) having a frequency equal to or larger than a predetermined value. By displaying the directed line segments 15 each indicating inter-page transition having a frequency equal to or larger than the predetermined value, the administrator of the hypertext 3 who refers to this analysis result can understand transition (access) frequencies between pages 2 at a glance.

Moreover, an entrance indicates that each visitor starts access to this hypertext 3 from another home page, and an exit indicates that each visitor quits access to this hypertext 3. Therefore, the number of sessions of the entrance and exit corresponds to a maximum value.

In this analysis result, a page 2 with page No. 483 is the target page. Therefore, all sessions 14 which passed this page 2 are determined as successful sessions, and the success ratio of the page 2 with page No. 483 is 100%.

The administrator of the hypertext 3 changes the contents and link configuration of respective pages 2 which form the hypertext 3 with reference to the analysis result of FIG. 4. For example, some sessions 14 make transition from a page 2 of No. 51 to the page 2 of No. 483 as the target page, but most of sessions 14 make transition from the page 2 of No. 51 to a page 2 of No. 55. In such case, the administrator of the hypertext 3 must change the link structure to allow easy transition from the page 2 of No. 51 to the page 2 of No. 483.

On the other hand, when many sessions 14 make transition from a page 2 of No. 715 to the exit, the administrator of the hypertext 3 must change the page contents to make transition from the page 2 of No. 715 to a page 2 of No. 16.

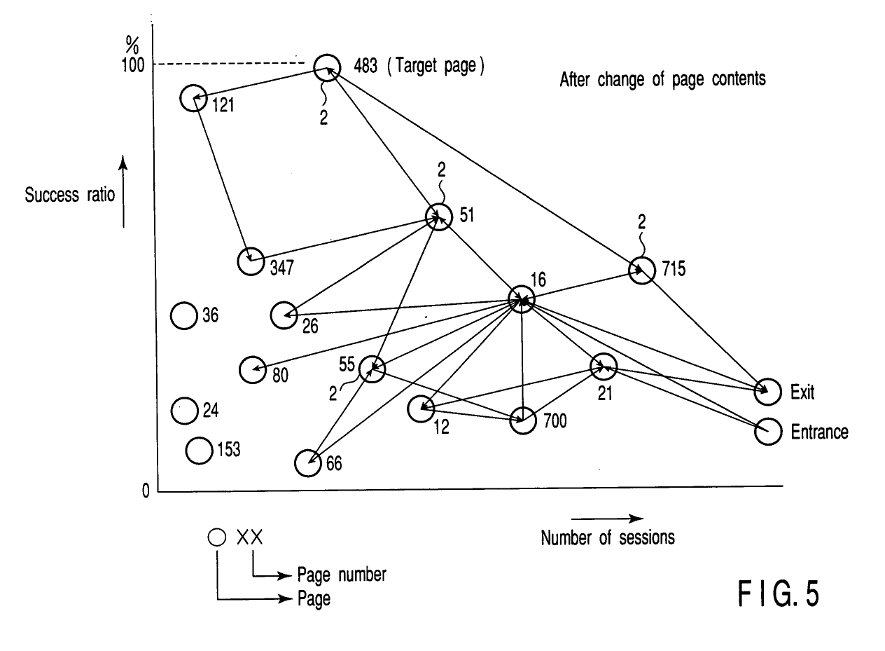

FIG. 5 shows the graph of the analysis result obtained upon analyzing the hypertext 3 again after the administrator of the hypertext 3 has changed the contents of the pages 2 of Nos. 51 and 715, and activated the Web server 1 for a predetermined period.

As can be understood from this analysis result, the success ratio of the page 2 of No. 51 increases, and the number of sessions of the page 2 (target page) of No. 483 increases, since the number of sessions which make transition from the page 2 of No. 51 to the page 2 of No. 55 decreases, and the number of sessions which make transition to the page 2 of No. 483 increases.

By changing the contents of the page 2 of No. 715, the number of sessions that make transition to the exit decreases, and the number of sessions that return to a page 2 of No. 16 increases. As a result, the success ratio of the page 2 of No. 715 increases.

In this manner, the administrator of the hypertext 3 modifies the page contents and link configuration with reference to the analysis result of the hypertext 3 shown in FIG. 4 and in consideration of the numbers of sessions, success ratios, and principal transition destination pages of the respective pages 2. As a result, the access frequency and success ratio of each page 2 can be increased, and the access frequency (the number of sessions) of the target page can be raised, thus greatly increasing business chances.

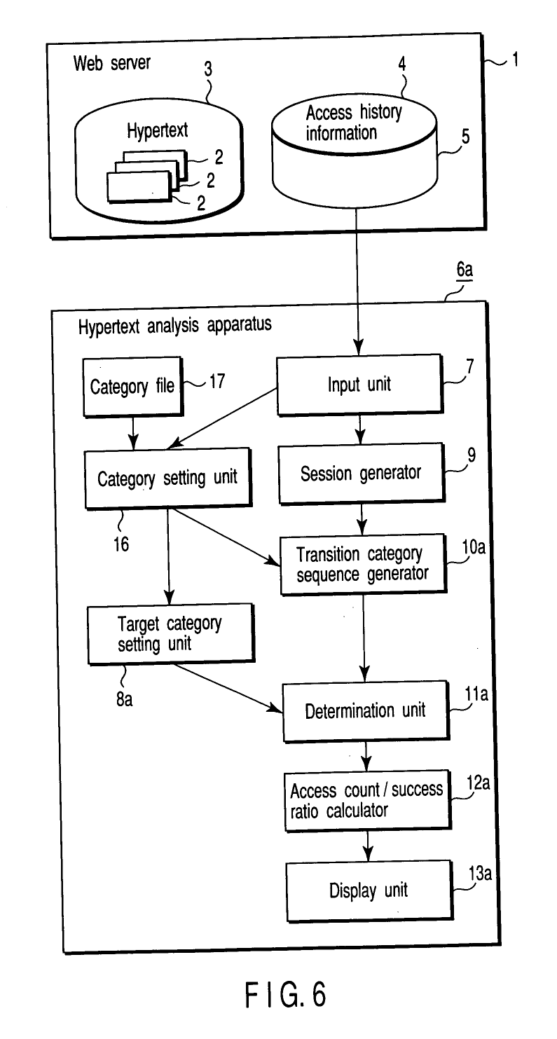

FIG. 6 is a schematic block diagram showing the arrangement of a hypertext analysis apparatus to which a hypertext analysis method according to the second embodiment of the present invention is applied and in which a hypertext analysis program is installed. The same reference numerals in FIG. 6 denote the same parts as in the hypertext analysis apparatus 6 of the first embodiment shown in FIG. 1, and a detailed description thereof will be omitted.

In FIG. 6, the arrangement of a Web server 1 is the same as that of the Web server 1 shown in FIG. 1. A hypertext analysis apparatus 6a, which comprises a computer of the second embodiment, includes an input unit 7, category setting unit 16, target category setting unit 8a, session generator 9, transition category sequence generator 10a, determination unit 11a, and access count/success ratio calculator 12a, which are implemented in an application program. Furthermore, the hypertext analysis apparatus 6a includes a category file 17 and display unit 13a.

The category file 17 stores categories (classes) upon classifying pages 2 which form the hypertext 3 into a plurality of categories (classes). For example, when the hypertext 3 is designed to practice Web sales, “merchandise purchase”, “merchandise information”, “purchase guide”, . . . , and the like are stored as categories (classes) of the pages 2.

The input unit 7 reads out access history information 4 stored in a log file 5 in the Web server 1, and outputs it to the category setting unit 16 and session generator 9.

The category setting unit 16 determines which of the categories stored in the category file 17 pages 2 contained in the access history information 4 input via the input unit 7, i.e., the hypertext 3 belong to in accordance with operation designations by the operator (administrator) of this hypertext analysis apparatus 6a. The unit 16 then outputs a page-category correspondence table in which a corresponding category 18 is appended to each page 2, as shown in FIG. 8, to the transition category sequence generator 10a. Furthermore, the category setting unit 16 outputs the set categories 16 to the target category setting unit 8a.

The target category setting unit 8a sets, as a target category, a category 18 to be visited (accessed) by visitors (access users) of the plurality of input categories 18, and outputs it to the determination unit 11a. The target category is designated by operation of the operator (administrator) of the hypertext analysis apparatus 6a.

The session generator 9 divides the input access history information 4 into sessions each indicating a series of access pages of a given visitor by it into visitors (access users), and outputs page sequences of the divided sessions to the transition page sequence generator 10.

The transition category sequence generator 10a rearranges page sequences of the sessions input from the session generator 9 in an order of transition. The generator 10a then converts the page sequences into category sequences on the basis of the page-category correspondence table input from the category setting unit 16. The generator 10a outputs the category sequences of the respective sessions to the determination unit 11a. FIG. 9 shows a session 14a that includes a transition-order category sequence. As shown in FIG. 9, the session 14a is obtained by replacing pages 2 in the session 14 shown in FIG. 3 by corresponding categories 18.

The determination unit 11a compares the transition-order category sequences of the respective sessions 14a transmitted from the transition category sequence generator 10a with the target category transmitted from the target category setting unit 8a to check if each session 14a includes the target category. The determination unit 11a determines a session 14a that includes the target category as a successful session, and a session that does not include the target category as an unsuccessful session. The determination unit 11a outputs the transition-order category sequences of the respective sessions 14a and the determination result to the access count/success ratio calculator 12a.

The access count/success ratio calculator 12a counts the number of sessions 14a which passed (accessed) each of the categories 18 corresponding to the pages 2, and the number of sessions 14a which are determined as “successful sessions” of the access sessions. Then, the access count/success ratio calculator 12a calculates a success ratio indicating the ratio of the number of successful sessions to the number of access sessions. The calculator 12 outputs the numbers of sessions and success ratios for respective categories 18 to the display unit 13a.

Note that a session 14a determined as a successful session can be limited to only a category sequence until the target category is accessed upon calculating the success ratio of each category 18.

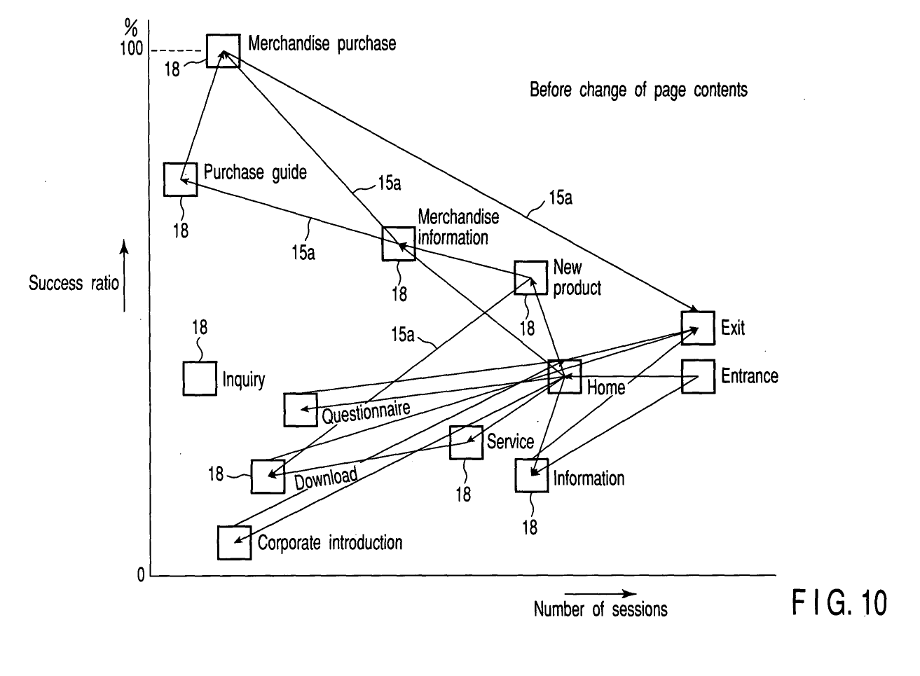

The display unit 13a plots respective categories 18 on an orthogonal coordinate system, the abscissa of which plots the number of sessions that passed a given category, and the ordinate of which plots the success ratio, as shown in FIG. 10. The graph obtained by plotting the respective categories 18 on the orthogonal coordinate system is displayed as the analysis result.

The administrator of the hypertext 3 can reform the link configuration among pages 2 corresponding to the categories 18 of the hypertext 3 and page contents with reference to the graph of the analysis result displayed on the display unit 13a.

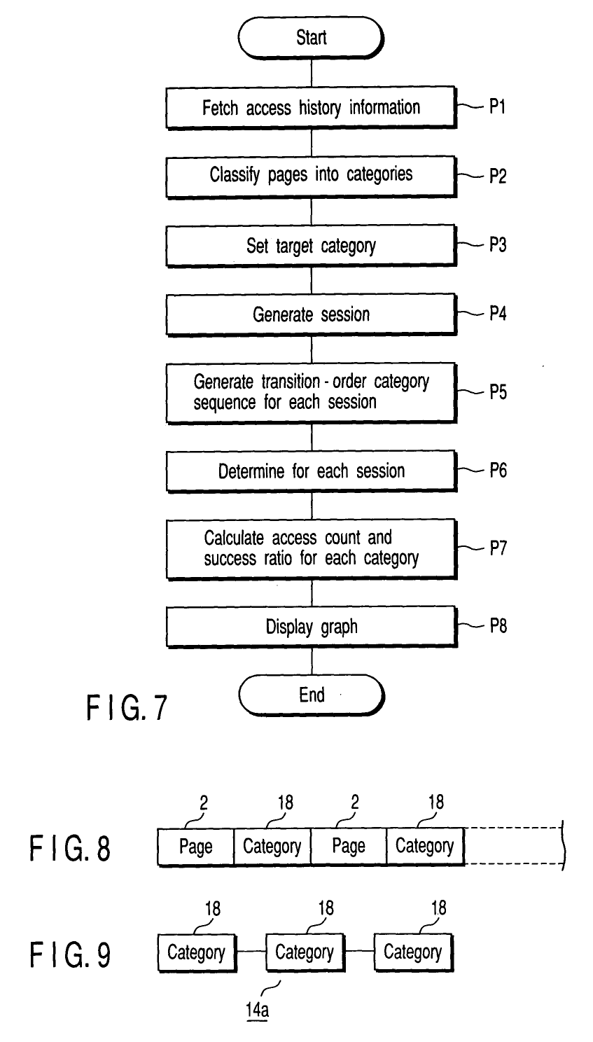

The detailed processing sequence in the hypertext analysis apparatus 6a with the above arrangement will be described below using the flow chart of FIG. 7.

The input unit 7 reads out the access history information 4 stored in the Web server 1 and outputs it to the session generator 9 and category setting unit 16 (step P1). The category setting unit 16 appends corresponding categories 18 to the input pages 2 and outputs them to the transition category sequence generator 10a. Also, the unit 16 outputs the set categories 18 to the target category setting unit 8a (step P2).

The target category setting unit 8a sets, as a target category, a category 18 to be visited by visitors of the input categories, and outputs it to the determination unit 11a (step P3).

The session generator 9 divides the input access history information 4 into a plurality of sessions, each of which indicates a series of accesses to respective pages 2 by one visitor (access user), and outputs the divided sessions to the transition category sequence generator 10a (step P4).

The transition category sequence generator 10a rearranges the page sequences of the sessions 14 input from the session generator 9 in an order of transition, and then converts the page sequences into category sequences on the basis of the page-category correspondence table input from the category setting unit 16. The generator 10a outputs the category sequences as the sessions 14a shown in FIG. 9 to the determination unit 11a (step P5).

The determination unit 11a compares the transition-order category sequences for respective sessions 14a with the target category. The unit 11a determines a session 14a that includes the target category as a successful session, and a session 14a that does not include any target category as an unsuccessful session. The unit 11a outputs the determination result to the access count/success ratio calculator 12a (step P6).

The access count/success ratio calculator 12a calculates the number of sessions 14a that passed each of the categories 18 and the success ratio, and outputs them to the display unit 13a (step P7). The display unit 13a displays the graph of the analysis result obtained by plotting the respective categories 18 on the orthogonal coordinate system the abscissa of which plots the number of sessions that passed a given page, and the ordinate of which plots the success ratio (step P8).

The analysis result obtained upon analyzing the hypertext 3 actually formed in the Web server 1 using the hypertext analysis apparatus 6a of the second embodiment with the above arrangement will be described below using FIG. 10.

The hypertext analysis apparatus 6a of this embodiment analyzes the hypertext 3 which is made up of a plurality of pages 2 that link with each other and practices Web sales of merchandise via the Internet. Therefore, a category 18 of “merchandise purchase” corresponding to a page 2 on which each visitor (access user=customer) finally instructs to purchase merchandise is set as a target category.

The pages 2 of the hypertext 3 of Web sales are classified to categories 18 such as “purchase guide”, “merchandise information”, “new product”, “inquiry”, “questionnaire”, “home”, “service”, “download”, “information”, “corporate introduction”, and the like in addition to the category 18 of “merchandise purchase”.

On the graph of the analysis result in FIG. 10, each square indicates a category, and text on the right side of the square indicates a category name. Furthermore, the abscissa plots the number of sessions 14a that passed each category 18, and the ordinate plots the success ratio indicating the ratio of the number of successful sessions 14a that passed the target category of the number of sessions 14a that passed each category 18. Furthermore, each directed line segment 15a that connects between categories 18 on the graph represents inter-category transition (inter-category access) having a frequency equal to or larger than a predetermined value.

Moreover, an entrance indicates that each visitor starts access to this hypertext 3 from another home page, and an exit indicates that each visitor quits access to this hypertext 3. Therefore, the number of sessions of the entrance and exit corresponds to a maximum value.

In this analysis result, a category 18 of “merchandise purchase” is the target category. Therefore, all sessions 14a which passed this category 18 are determined as successful sessions, and the success ratio of the category 18 of “merchandise purchase” is 100%.

The administrator of the hypertext 3 changes the contents and link configuration of respective pages 2 which form the hypertext 3 with reference to the analysis result of FIG. 10. For example, when a transition is made from a category 18 of “new product” to the category of “merchandise information”, the probability of transition to the category 18 of “merchandise purchase” as the target category increases. However, when a transition is made from the category of “new product” to a category 18 of “download”, the success ratio decreases.

Hence, the administrator of the hypertext 3 must change the link structure to allow easy transition from the category of “new product” to the category 18 of “merchandise information”. Also, since most sessions make transition from a category 18 of “home” to a category 18 of “information” and then to the exit, the administrator must change the page contents of the category 18 of “information”.

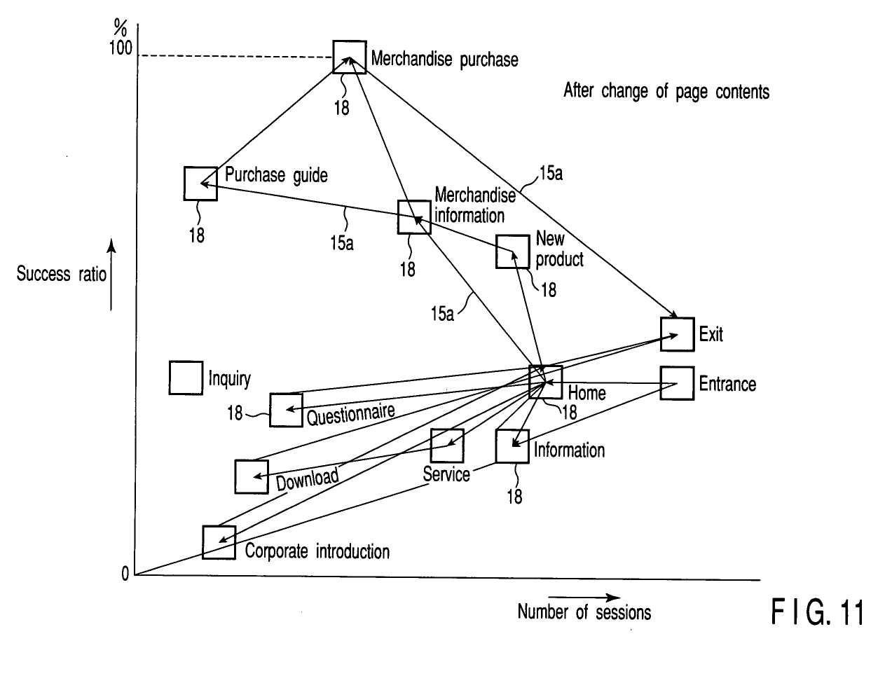

FIG. 11 shows the graph of the analysis result obtained upon analyzing the hypertext 3 again after the administrator of the hypertext 3 has changed the contents of the pages 2 corresponding to the categories 18 of “new product” and “information”, and activated the Web server 1 for a predetermined period.

As can be understood from this analysis result, the success ratio of the category 18 of “new product” increases, and the number of sessions of the category 18 of “merchandise purchase” increases, since the number of sessions which make transition from the category 18 of “new product” to the category 18 of “download” decreases, and the number of sessions which make transition to the category 18 of “merchandise information” increases.

Since the contents of the page 2 corresponding to the category 18 of “information” have been changed, the number of sessions that make transition to the exit decreases, and the number of sessions that return to the category 18 of “home” increases, thus increasing the success ratio of the category 18 of “information”.

In this manner, the administrator of the hypertext 3 modifies the page contents and link configuration of the pages 2 corresponding to the categories 18 with reference to the analysis result of the hypertext 3 shown in FIG. 10 and in consideration of the numbers of sessions, success ratios, and principal transition destination categories of the respective categories 18. As a result, the access frequency and success ratio of each category 18 can be increased, and the access frequency (the number of sessions) of the target category can be raised, thus increasing business chances.

Furthermore, in the hypertext analysis apparatus 6a of the second embodiment, many pages 2 which form the hypertext 3 are classified into a plurality of categories 18, and the hypertext 3 is analyzed based on the access history to these categories 18, thus graphically displaying the analysis result, as shown in FIG. 10.

Therefore, when the administrator of the hypertext 3 modifies the page contents and link configuration with reference to the displayed analysis result, he or she can recognize the analysis result for respective categories, thus improving the modification efficiency. Furthermore, since the pages 2 can be classified into categories 18 and analysis is made for respective categories, the computer resources and calculation time can be greatly reduced.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A hypertext analysis method for analyzing hypertext which is formed in a network server and links a plurality of pages with each other, comprising:
fetching access history information to respective pages of the hypertext stored in the network server;
setting one or a plurality of pages designated from the plurality of pages that form the hypertext as a target page or pages;
dividing the fetched access history information into a plurality of sessions each indicating a series of accesses;
generating a page sequence in an order of transition of pages included in each of the divided sessions, and storing the page sequence in a memory;
determining each of the sessions, which accesses the target page, as a successful session, and a session, which does not access the target page, as an unsuccessful session;
calculating, for each of pages which form the hypertext, the number of sessions which accessed that page, and a success ratio as a ratio of the number of successful sessions to the number of access sessions; and
outputting the numbers of sessions and success ratios of the respective pages as an analysis result.

2. A method according to claim 1, wherein the outputting includes a generating a graph obtained by plotting the respective pages on an orthogonal coordinate system, one of orthogonal axes of which plots the number of access sessions, and the other axis of which plots the success ratio, and outputting the graph as the analysis result.

3. A method according to claim 1 or 2, wherein a successful session corresponds to only a page sequence until the target page is accessed in the calculating the number of sessions and success ratio.

4. A method according to claim 2, wherein the outputting includes a displaying a directed line segment between pages corresponding to inter-page accesses of not less than a predetermined frequency.

5. A hypertext analysis method for analyzing hypertext which is formed in a network server and links a plurality of pages with each other, comprising:
fetching access history information to respective pages of the hypertext stored in the network server;
classifying respective pages that form the hypertext into a plurality of categories;
setting one or a plurality of categories designated from the plurality of categories as a target category or categories;
dividing the fetched access history information into a plurality of sessions each indicating a series of accesses;
generating a category sequence in an order of transition of categories corresponding to pages included in each of the divided sessions, and storing the category sequence in a memory;
determining each of the sessions, which accesses the target category, as a successful session, and a session, which does not access the target category, as an unsuccessful session;
calculating, for each of categories corresponding to the pages which form the hypertext, the number of sessions which accessed that category, and a success ratio as a ratio of the number of successful sessions to the number of access sessions; and
outputting the numbers of sessions and success ratios of the respective categories as an analysis result.

6. A method according to claim 5, wherein the outputting step includes a generating a graph obtained by plotting the respective categories on an orthogonal coordinate system, one of orthogonal axes of which plots the number of access sessions, and the other axis of which plots the success ratio, and outputting the graph as the analysis result.

7. A method according to claim 5 or 6, wherein a successful session corresponds to only a category sequence until the target category is accessed in the calculating the number of sessions and success ratio.

8. A method according to claim 6, wherein the outputting includes a displaying a directed line segment between categories corresponding to inter-category accesses of not less than a predetermined frequency.

9. A method according to claim 6, wherein the hypertext pertains to Web sales of merchandise, and the one or plurality of target categories include a “merchandise purchase” category.

10. A computer program product for a hypertext analysis program for analyzing hypertext which is formed in a network server and links a plurality of pages with each other, comprising:
fetching access history information to respective pages of the hypertext stored in the network server;
setting one or a plurality of pages designated from the plurality of pages that form the hypertext as a target page or pages;
dividing the fetched access history information into a plurality of sessions each indicating a series of accesses;
generating a page sequence in an order of transition of pages included in each of the divided sessions, and storing the page sequence in a memory;
determining each of the sessions, which accesses the target page, as a successful session, and a session, which does not access the target page, as an unsuccessful session;
calculating, for each of pages which form the hypertext, the number of sessions which accessed that page, and a success ratio as a ratio of the number of successful sessions to the number of access sessions; and
outputting the numbers of sessions and success ratios of the respective pages as an analysis result.

11. A computer program product for a hypertext analysis program for analyzing hypertext which is formed in a network server and links a plurality of pages with each other, comprising:
fetching access history information to respective pages of the hypertext stored in the network server;
classifying respective pages that form the hypertext into a plurality of categories;
setting one or a plurality of categories designated from the plurality of categories as a target category or categories;
dividing the fetched access history information into a plurality of sessions each indicating a series of accesses;
generating a category sequence in an order of transition of categories corresponding to pages included in each of the divided sessions, and storing the category sequence in a memory;
determining each of the sessions, which accesses the target category, as a successful session, and a session, which does not access the target category, as an unsuccessful session;
calculating, for each of categories corresponding to the pages which form the hypertext, the number of sessions which accessed that category, and a success ratio as a ratio of the number of successful sessions to the number of access sessions; and
outputting the numbers of sessions and success ratios of the respective categories as an analysis result.

12. A hypertext analysis apparatus for analyzing hypertext which is formed in a network server and links a plurality of pages with each other, comprising:
means for fetching access history information to respective pages of the hypertext stored in the network server;
means for setting one or a plurality of pages designated from the plurality of pages that form the hypertext as a target page or pages;
means for dividing the fetched access history information into a plurality of sessions each indicating a series of accesses;
means for generating a page sequence in an order of transition of pages included in each of the divided sessions, and storing the page sequence in a memory;
means for determining each of the sessions, which accesses the target page, as a successful session, and a session, which does not access the target page, as an unsuccessful session;
means for calculating, for each of pages which form the hypertext, the number of sessions which accessed that page, and a success ratio as a ratio of the number of successful sessions to the number of access sessions; and
means for outputting the numbers of sessions and success ratios of the respective pages as an analysis result.

13. A hypertext analysis apparatus for analyzing hypertext which is formed in a network server and links a plurality of pages with each other, comprising:
means for fetching access history information to respective pages of the hypertext stored in the network server;
means for classifying respective pages that form the hypertext into a plurality of categories;
means for setting one or a plurality of categories designated from the plurality of categories as a target category or categories;
means for dividing the fetched access history information into a plurality of sessions each indicating a series of accesses;
means for generating a category sequence in an order of transition of categories corresponding to pages included in each of the divided sessions, and storing the category sequence in a memory;
means for determining each of the sessions, which accesses the target category, as a successful session, and a session, which does not access the target category, as an unsuccessful session;
means for calculating, for each of categories corresponding to the pages which form the hypertext, the number of sessions which accessed that category, and a success ratio as a ratio of the number of successful sessions to the number of access sessions; and
means for outputting the numbers of sessions and success ratios of the respective categories as an analysis result.
